(19) United States
(12) Patent Application Publication
(10) Pub. No.: US 2009/0246309 A1
(43) Pub. Date: Oct. 1, 2009

(54) FINE STRUCTURE IMPRINTING MACHINE

(76) Inventors: Ryuta WASHIYA, Hitachi (JP); Takashi Ando, Hitachi (JP); Masahiko Ogino, Hitachi (JP); Noritake Shizawa, Ninomiya (JP); Kyoichi Mori, Oiso (JP); Akihiro Miyauchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/388,653

(22) Filed: Feb. 19, 2009

(30) Foreign Application Priority Data
Mar. 31, 2008 (JP) 2008-089849

(51) Int. Cl. B29C 59/02

(52) U.S. Cl. 425/174.6

(57) ABSTRACT

A fine structure imprinting machine is provided which can surely and easily eliminate static electricity in removing a stamper from an imprinting object. The fine structure imprinting machine is adapted to bring the stamper with a fine concavo-convex pattern formed thereon into contact with the imprinting object, thereby to imprint the fine concavo-convex pattern of the stamper onto a surface of the imprinting object. The stamper has a conductive film on at least a pattern formation surface thereof. The stamper is fixed by a conductive holding member, the conductive film is connected to the holding member via the conductor, and the holding member is connected to a ground within the machine.

The present application claims priority from Japanese Patent Application No. 2008-089849 filed on Mar. 31, 2008, the content of which is hereby incorporated by reference into this application.

### BACKGROUND OF THE INVENTION

1. Field of the Invention

The present invention relates to a fine structure imprinting machine for imprinting a fine concave-convex shape of a stamper onto a surface of an imprinting object.

2. Description of the Related Art

In recent years, semiconductor integrated circuits have been increasingly microfabricated. In order to achieve such a microfabrication process, for example, the accuracy of forming a pattern of a semiconductor integrated circuit by a photolithography device has been enhanced. On the other hand, since the order of microfabrication process gets close to the wavelength of an exposure light source, the enhancement of the accuracy of pattern formation is approaching to the limit. Thus, an electron beam drawing device, which is a type of charged particle beam equipment, has come into use so as to further enhance the accuracy, in place of the photolithography technique.

For this reason, a collective figure irradiation method has been developed which involves collectively irradiating a combination of masks having various shapes with electron beams at a time so as to speed up the pattern formation by the electron beam drawing device.

However, the electron beam drawing device using the collective figure irradiation method has to be upsized, and a mechanism for more accurately controlling the positions of the masks is further required, which results in an increase in cost of the device.

An imprint technique which involves pressing a predetermined stamper to transfer the surface shape of the stamper is known as another technique of forming a pattern. The imprint technique involves pressing the stamper with concavities and convexities corresponding to a concavo-convex pattern to be formed against an imprinting object obtained, for example, by forming a resin layer on a predetermined substrate. This technique can form the fine structure having the concavo-convex width of 25 nm or less on the resin layer of the imprinting object. The resin layer having such a pattern formed thereon (hereinafter referred to as a “pattern formation layer”) includes a thin film layer formed on a substrate, and a pattern containing convexities formed on the thin film layer. The imprint technique is now considered to be applied to formation of a pattern of recording pits on a high-capacity recording medium, or formation of a pattern on a semiconductor integrated circuit. For example, a substrate for the high-capacity recording medium or a substrate for the semiconductor integrated circuit can be produced by etching exposed parts of the thin film layer located at concavities of the pattern formation layer, and parts of the substrate in contact with the thin film layer parts, using convexities of the pattern formation layer formed by the imprint technique as a mask.

When light curing resin is used as material for the pattern formation layer, it is necessary to apply ultraviolet light from one of the substrate and the stamper to the light curing resin, while pressing the substrate against the stamper, thereby curing the resin. At this time, when the ultraviolet light can pass through from the stamper, the imprint can be performed regardless of opaqueness of the imprinting object, which is expected to be applied to various fields. The transparent stamper is made of quartz, resin, or the like from the viewpoint of transparency, processing accuracy, and the like.

The quartz or resin, however, is an insulating material, and thus easily tends to generate static electricity in removing the stamper from the substrate. The static electricity needs a large force for removing the stamper from the substrate. Further, the static electricity attracts surrounding foreign matter. The foreign matter sandwiched between imprinting surfaces may cause defects. Thus, imprinting using the insulating stamper needs to eliminate the static electricity caused in removing the stamper from the imprinting object.

One of methods for eliminating static electricity involves incorporating an ionizer in a device, and feeding an ionized airflow in removing the stamper from the substrate, thereby eliminating the static electricity in the removing process, as disclosed and proposed in, for example, JP-A-No. 98779/2007.

In the method disclosed in JP-A-No. 98779/2007, however, the ionized airflow has to be fed to a removing interface between the stamper and the substrate, which needs a gap sufficient for the airflow to enter therebetween. The stamper and the imprinting object being charged requires the strong removing force, and cannot have the sufficient gap therebetween. When the sufficient gap is not opened, the ionized airflow cannot be fed, and thus the static electricity cannot be eliminated. On the other hand, in application of the strong force for removing the stamper from the imprinting object, the sufficient gap for feeding the airflow can be ensured, but the load is also applied to the device and the stamper, which may lead to breakage of the device in the worst case.

The present invention has been made in view of the forgoing circumstances, and it is an object of the invention to provide a fine structure imprinting machine which can eliminate static electricity in removing a stamper from an imprinting object without applying load to the imprinting device itself and the stamper.

### SUMMARY OF THE INVENTION

In order to solve the foregoing problems, the invention is directed to a fine structure imprinting machine for bringing a stamper with a fine concavo-convex pattern formed thereon into contact with an imprinting object, thereby to imprint the fine concavo-convex pattern of the stamper onto a surface of the imprinting object. The stamper has a conductive film on at least a pattern formation surface (imprinting surface) thereof. The stamper is fixed to a conductive holding member. The conductive film, the holding member, and the conductor are connected to each other. Further, the holding member is connected to a ground within the machine.

In a fine structure imprinting machine according to another aspect of the invention, conductive films are formed on a pattern formation surface (imprinting surface) of a stamper, and a back side thereof. The conductive films formed on the pattern formation surface and on the back side are connected to each other via the conductor (conductive path provided in the stamper). Further, a conductor of the holding member is connected to the ground within the machine.

In a fine structure imprinting machine according to still another aspect of the invention, a conductive film is continuously formed over a pattern formation surface (imprinting surface) of a stamper, a back side thereof, and a side surface thereof. At least a part of the back side of the pattern formation surface of the stamper is connected to a conductor of a holding member. The conductor of the holding member is connected to the ground within the machine.

In a fine structure imprinting machine according to a further aspect of the invention, a conductive film is continuously formed on a pattern formation surface (imprinting surface) of a stamper, and a side surface thereof. A conductor of a holding member is in contact with the conductive film of the stamper at the side surface thereof. The holding member is connected to the ground within the machine.

In a fine structure imprinting machine according to a still further aspect of the invention, a conductive film is formed on a pattern formation surface (imprinting surface) of the stamper, and a holding member lifts (places) and holds an outer periphery (a part without the pattern) of the pattern formation surface of the stamper. A conductor of the holding member is connected to the ground within the machine.

The fine structure imprinting machine with the above arrangement releases static electricity generated in the stamper to the ground via the conductive film and the conductor of the holding member.

The features of the invention will be better understood by reference to the accompanying drawings which illustrate presently preferred embodiments of the invention.

The fine structure imprinting machine according to the invention can surely and easily eliminate the static electricity in removing the stamper from the imprinting object.

### BRIEF DESCRIPTION OF THE DRAWINGS

FIG. 1 is a schematic diagram showing a structure of a fine structure imprinting machine according to a first embodiment of the invention;

FIGS. 2A to 2C are schematic diagrams showing a structure of a plate 6 of the fine structure imprinting machine;

FIGS. 3A to 3D are schematic diagrams showing a step of a fine structure imprinting method;

FIG. 4 shows an electron microscope image of a section of a pattern formation layer including a thin film layer and a pattern layer, and formed by use of the fine structure imprinting machine;

FIG. 5A and 5B are explanatory diagrams of a stamper structure according to a second embodiment;

FIG. 6 is an explanatory diagram of a stamper structure according to a third embodiment;

FIG. 7 is an explanatory diagram of a stamper structure according to a fourth embodiment;

FIGS. 8A to 8E are explanatory diagrams showing a manufacturing step of a stamper according to a fifth embodiment;

FIG. 9 is a schematic diagram showing a structure of a fine structure imprinting machine according to a sixth embodiment of the invention;

FIG. 10 is a schematic diagram showing a structure of a fine structure imprinting machine according to a seventh embodiment of the invention;

FIGS. 11A to 11D are explanatory diagrams showing a step of a manufacturing procedure (1) of a discrete track medium;

FIGS. 12A to 12E are explanatory diagrams showing a step of a manufacturing procedure (2) of a discrete track medium;

FIGS. 13A to 13E are explanatory diagrams showing a step of a manufacturing procedure (3) of a discrete track medium;

FIGS. 14A to 14E are explanatory diagrams showing a step of a manufacturing procedure (4) of a discrete track medium;

FIG. 15 is a schematic diagram showing a configuration of an optical circuit serving as a basic component of an optical device;

FIG. 16 is a schematic diagram showing a structure of a waveguide of the optical circuit; and

FIGS. 17A to 17L are explanatory diagrams showing a manufacturing step of a multilayer wiring board.

### DETAILED DESCRIPTION OF THE PREFERRED EMBODIMENTS

Preferred embodiments of the invention will be described below with reference to the accompanying drawings. It is to be noted that the preferred embodiments are illustrative for implementing the invention rather than limiting the technical scope of the invention. In each drawing, the same reference numbers will be used to refer to the same or like parts.

### (1) First Embodiment

### (Structure of Fine Structure Imprinting Machine)

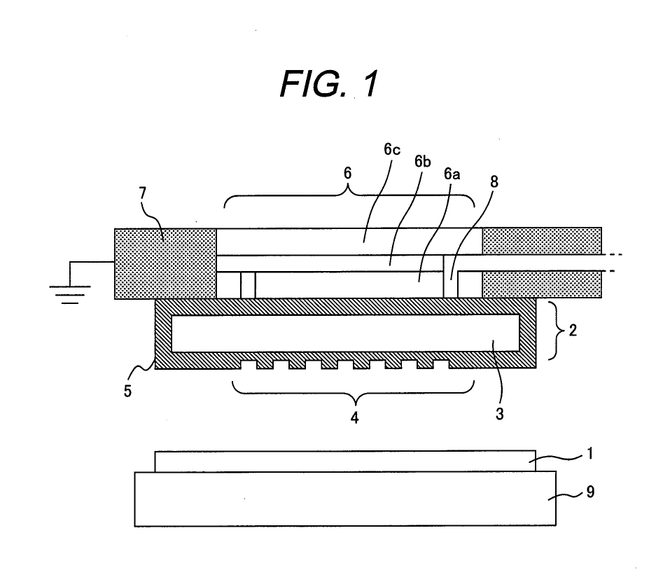

FIG. 1 is a schematic diagram of a structure of a fine structure imprinting machine according to a first embodiment of the invention. As shown in FIG. 1, the fine structure imprinting machine includes a plate 6 for sucking a stamper 2, and a stamper holding member 7 having an electric conductor formed therein. The stamper holding member 7 is connected to a ground E within the machine by means (not shown).

The stamper 2 is formed such that a conductive film 5 covers a substrate 3 for allowing ultraviolet (UV) light to pass therethrough. A fine concavo-convex pattern 4 is formed on one surface of the conductive film 5. The stamper 2 is fixed to the plate 6 by means of a vacuum suction port 8. The stamper 2 is manufactured in the following way. The substrate 3 of the stamper 2 in use is made of, for example, a quartz substrate having a diameter of 100 mm and a thickness of 1.0 mm. The conductive film 5 is formed in a thickness of 100 nm on one side of the substrate 3 by sputtering of indium tin oxide (ITO). Then, grooves having a width of 50 nm, a depth of 80 nm, and a pitch of 100 nm are concentrically formed to form a pattern 4 on a surface of the conductive film 5 within a range of 65 nm in diameter from the center of the substrate 3 by the known electron beam drawing method. The ITO material is formed in a thickness of 100 nm by sputtering on each of the side surface of the substrate 3 and the back side of the pattern 4.

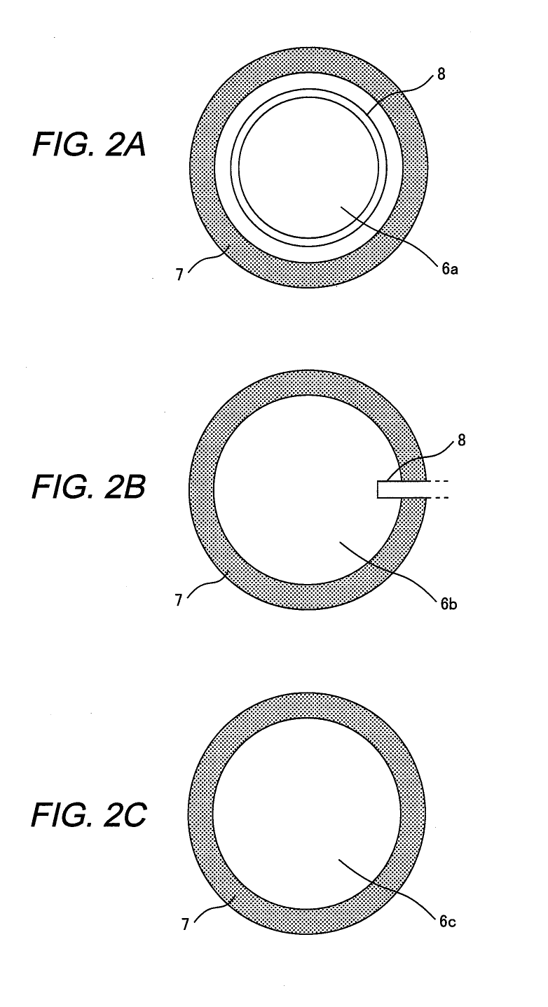

The plate 6 is constructed of three transparent plates 6a, 6b, and 6c. FIGS. 2A, 2B, and 2C show the constructions of the plates 6a, 6b, and 6c. The vacuum suction port 8 is connected to exhaust means, such as a vacuum pump (not shown) or the like. The plate 6 may not be divided into a plurality of members shown in FIGS. 2A to 2C, and may be an integrated structure similar to the structure described above.

The stamper 2 is disposed such that the back side of at least an area having the pattern 4 formed thereon is in contact with the plate (made of, for example, quartz) 6. The exhaust operation is performed through the exhaust means (not shown), causing the stamper 2 to be vacuum-sucked to the plate 6. The back side of the pattern 4 of the stamper 2 is disposed to be in contact with the stamper holding member 7.

The imprinting object 1 is held by the stage 9. The stage 9 is designed so as to keep the plate 6 and the imprinting object 1 in parallel to each other. The stage 9 has a lifting and lowering mechanism for removing the stamper 2 from the imprinting object 1 in parallel to each other by pressurizing them. For example, the imprinting object 1 in use is made of a glass substrate having a diameter of 100 mm and a thickness of 0.7 mm. The imprinting object 1 is vacuum-sucked and fixed to the stage 9 made of, for example, stainless material.

### (Each Step of Fine Structure Imprinting)

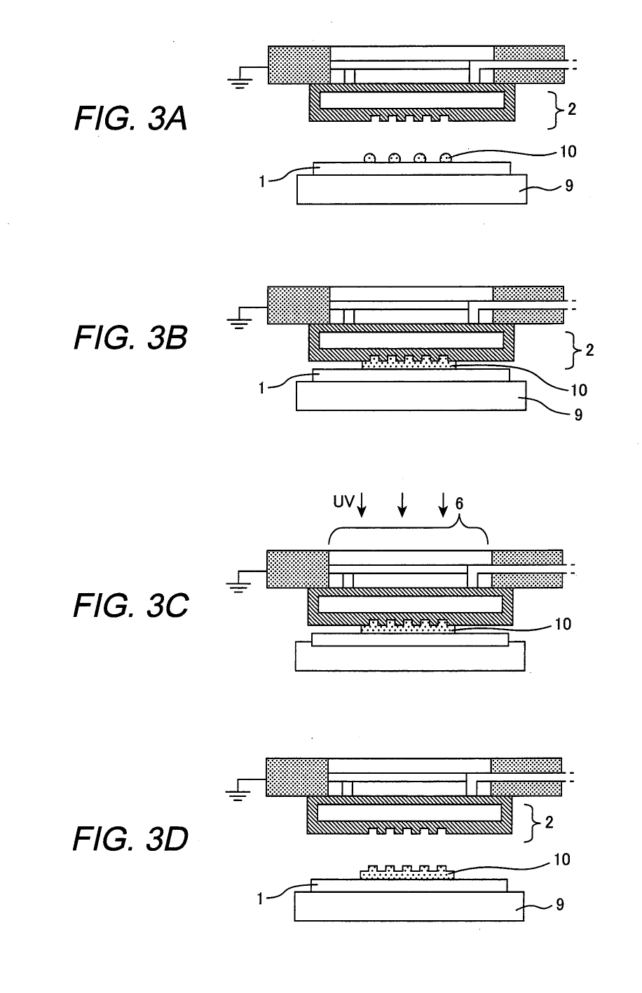

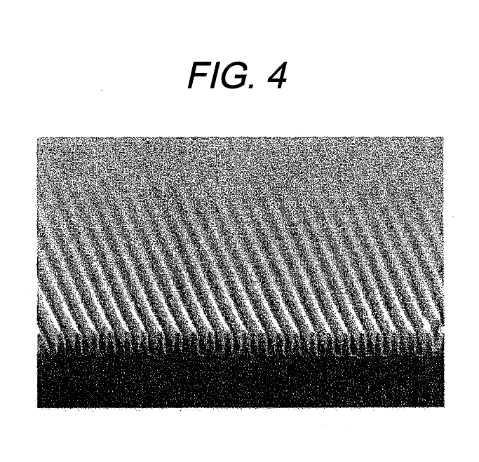

A fine structure imprinting method using the fine structure imprinting machine with the above-mentioned arrangement will be explained with reference to FIGS. 3A to 3D. That is, first, the imprinting object 1 previously coated with a light curing resin 10 is disposed on the stage 9 (see FIG. 3A). The resin applied to the surface of the imprinting object 1 is, for example, acrylate resin to which photosensitive material is added, and is preferably adjusted to have a viscosity of 4 mPa·s. The resin is applied by a coating head including 512 nozzles (256×2 columns) arranged for discharging resin by a piezoelectric system. A distance between the nozzles of the coating head is 70 μm in the direction of column, and 140 μm in the direction of the distance between the columns. The nozzles are controlled so as to discharge resin of about 5 PL from each nozzle. A drop pitch of the resin may be 150 μm in the radial direction, and 270 μm in the circumferential direction.

Subsequently, the stage 9 is lifted to press the imprinting object 1 against the stamper 2 thereby to expand the light curing resin 10 (see FIG. 3B). The ultraviolet rays are applied from the upper side of the plate 6 to cure the light curing resin 10 (see FIG. 3C). After curing the light curing resin 10, the stage 9 is lowered to remove the stamper 2 from the imprinting object 1 (see FIG. 3D). As a result, the pattern formation layer made of the light curing resin 10 is formed on the surface of the imprinting object 1.

Note that directly after removing the stamper 2 from the imprinting object 1, the charged state of the imprinting surface of the stamper 2 was measured by a static charge gauge. When the same experiment is performed using a stamper having a surface made of quartz, for example, the electric potential of about −10 kV was measured. On the other hand, the experiment was performed using the fine structure imprinting device of this embodiment, so that the measured electric potential was 0 V.

The fine structure imprinting machine described above can reduce electrostatic charge in removing the stamper from the imprinting object, and can also decrease the removing force, unlike the conventional imprinting machine and imprinting method (as disclosed in, for example, JP-A-No. 98779/2007). Further, the imprinting machine of this embodiment can prevent the electrostatic charge of the stamper 2. This embodiment of the invention is not limited to the embodiments disclosed herein, and various modifications can be made thereto as will be described later.

### MODIFIED EXAMPLE

Although in the first embodiment, the conductive film 5 is formed to cover the surface of the substrate 3, the conductive film 5 may be formed only on a formation surface of the pattern 4 and on the back side thereof. In this case, the formation surface of the pattern 4 of the substrate 3 needs to be connected to the conductive film 5 on the back side thereof via a conductor.

The conductive film 5 may be formed only on the formation surface of the pattern 4. In this case, the conductive film 5 needs to be connected to the stamper holding member 7 via the conductor.

The stamper 2 is vacuum-sucked and fixed to the plate 6, but maybe held by electrostatic chuck or mechanical measures.

In bringing the stamper 2 into contact with the imprinting object 1, the stamper 2 and the surface of the imprinting object 1 may be exposed to a reduced-pressure atmosphere, or to a gas atmosphere, such as nitrogen, so as to promote curing of the resin, and thereafter the stamper 2 and the imprinting object 1 may come into contact with each other.

Material for the pattern formation layer formed on the imprinting object 1 in use is the light curing resin 10 in this embodiment, but may be any known one. Specifically, resin material to which photosensitive material is added can be used. Resin materials include, as a main component, for example, cycloolefin polymer, polymethylmethacrylate, polystyrene polycarbonate, polyethylene terephthalate (PET), polylactic acid, polypropylene, polyethylene, polyvinyl alcohol, and the like.

The coating method of the light curing resin 10 can be a dispensing method, or a spin coat method in use. In the dispensing method, the light curing resin 10 is delivered by drops onto the surface of the imprinting object 1. The drops of the light curing resin 10 expand over the surface of the imprinting object 1 by bringing the pattern 4 into contact with the imprinting object 1. At this time, when a plurality of positions of the drops of the resin 10 exist, the distance between the centers of the drop positions is desirably set wider than the diameter of a droplet thereof. Further, the position of the drop of the light curing resin 10 may be defined based on a result of evaluation previously obtained about expansion of the light curing resin corresponding to the fine pattern to be formed. The amount of coating of the resin is adjusted to the same amount or more than that required for forming the pattern formation layer.

Imprinting objects which can be used in the invention, other than the above-mentioned imprinting object may include, for example, a member having a thin film made of other resin, such as thermosetting resin or thermoplastic resin, formed on a predetermined substrate, or a member made of only resin (including a resin sheet). In use of the thermoplastic resin, the temperature of the imprinting object is equal to or more than a glass transition temperature of the thermoplastic resin before pressing the stamper 2 against the imprinting object 1. After pressing the stamper 2, the imprinting object 1 and the stamper 2 are cooled in the case of the thermoplastic resin, or are held under a polymerization temperature condition in the case of the thermosetting resin, thereby curing the resin. When such resin is cured, then the stamper 2 is removed from the imprinting object 1, whereby the fine pattern of the stamper 2 can be imprinted onto the imprinting object 1 side.

Materials for the above-mentioned imprinting object 1 may include various kinds of material processed, for example, silicon, glass, aluminum alloy, resin, and the like. The imprinting object 1 may be a multilayer structure having a metal layer, a resin layer, an oxide film layer, and the like formed on a surface thereof.

The outer appearance of such an imprinting object 1 may be any one of a circular shape, an elliptical shape, and a polygonal shape according to the application of the imprinting object 1, and further may have a center hole processed.

Materials for the conductive film 5 of the stamper 2 may be in use transparent conductive materials, including alloy, such as indium tin oxide (ITO), indium zinc oxide, antimony oxide, antimony tin oxide, and conductive resin. Any metal or conductive material provided under a condition where enough light to cure the light curing resin passes through the material, for example, by thinning or the like, may be used.

In this embodiment, it is necessary to irradiate the light curing resin 10 applied to the imprinting object 1 with an electromagnetic wave, such as ultraviolet light, via the stamper 2. Thus, the substrate 3 and the plate 6 is made of one selected from transparent materials. At this time, the back side of the area having the pattern 4 of the stamper 2 formed thereon is held by the plate 6. In use of other materials to be processed, such as the thermosetting resin or thermoplastic resin, instead of the light curing resin, the transparency of the substrate 3 and the plate 6 may not have any importance.

The conductive film 5 and the stamper holding member 7 may be made of the same material or different materials. The pattern 4 of the stamper 2 may be manufactured by forming a fine pattern on the substrate 3 by the above-mentioned means, and forming a conductor on the surface of the pattern. Means for forming the conductor may include sputtering, vacuum deposition, spray coating, dip coating, CVD, and the like. Alternatively, the conductor may be formed by dispersing conductive fine particles in solvent, and coating the surface with the dispersion by the spin coat method.

The conductive film 5 is formed over the entire surface of the concavo-convex pattern of the pattern 4, but maybe formed only on the convexities. The conductive film 5 formed on the convexities is desirably extended continuously within the surface.

The pattern 4 of the stamper 2 may be formed by making a resin pattern on the conductive film 5 by an imprint method or the like. When the resin in use constitutes an insulating film, the thickness of the resin pattern may be preferably equal to or less than 100 μm because the thick resin pattern may prevent movement of electrons.

The outer appearance of the stamper 2 may be any one of a circular shape, an elliptical shape, and a polygonal shape, and further may have a center hole processed.

A mold release agent, such as a fluorinated agent or a silicon release agent, can be applied to the surface of the pattern 4 so as to promote removal of the pattern 4 from the light curing resin 10. Alternatively, a thin film made of a metal compound or the like can be formed on the surface of the pattern 4 as a release layer. Such a pattern 4 may have a different shape or superficial area from that of the imprinting object 1 as long as the pattern 4 can imprint the fine pattern onto a predetermined area of the imprinting object. When the mold release agent in use is an insulator, the thickness of the mold release agent may be preferably equal to or less than 100 μm because the thick mold release agent may prevent movement of electrons.

In this embodiment, the plate 6 for holding the stamper 2 is constructed of a plurality of transparent plates, but may be constructed of a single transparent plate. In this case, the plate 6 needs to be arranged so as not to interrupt application of ultraviolet light to the surface of the imprinting object 1. In processing the vacuum suction port by cutting, a grinding process for making a processing surface transparent is required.

In this embodiment, the imprinting object onto which the fine pattern is imprinted can be applied to information recording media, such as a magnetic recording medium, or an optical recording medium. Further, the imprinting object can also be applied to large-scale integrated circuit components, optical components, such as a lens, a polarizing plate, a wavelength filter, a light-emitting element, an optical integrated circuit, or the like, and biodevices for immune assay, DNA separation, cell culturing, and the like.

### (2) Second Embodiment

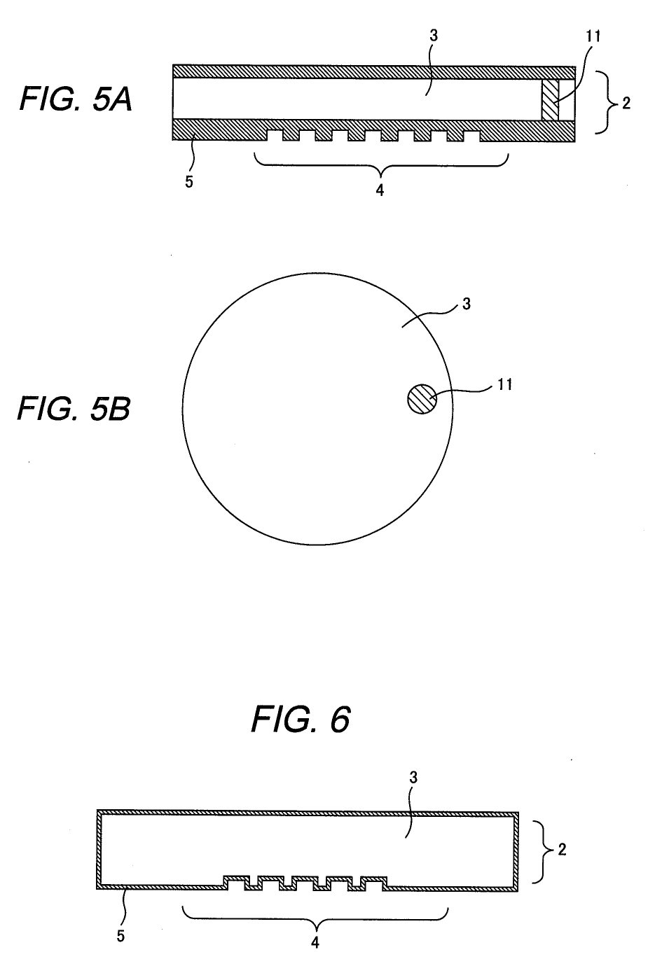

FIGS. 5A and 5B are diagrams showing a structure of a stamper 2 according to a second embodiment. The stamper 2 can also be used in the fine structure imprinting machine described in the first embodiment. The stamper 2 of the second embodiment has conductive films 5 formed only on an imprinting surface and the back side thereof, unlike the first embodiment. A conductive path 11 is further formed between the imprinting surface and the back side of the substrate 3. The formation of the conductive films 5 only on the imprinting surface and the back side thereof in this way is due to the fact that formation of the conductive film 5 at the edge of the substrate 3 is relatively difficult.

FIG. 5B is a diagram of the substrate 3 used in this embodiment as viewed from the upper side. The conductive path 11 of 5 mm in diameter is provided in the conductive films 5 formed on both sides of the substrate 3 in a position of 90 mm in diameter outside the periphery of a formation area of the pattern 4 on the substrate 3. An aluminum column having a diameter of 5 mm and a thickness of 0.7 mm is embedded in the conductive path 11. It is apparent that a conductive path is not limited to such a structure (position and size), and may be located in any other position with any other size. The conductive path 11 is preferably provided outside the pattern 4. This is because the stamper 2 allows the UV light to pass therethrough.

The use of the fine structure imprinting machine with such a stamper 2 forms a groove pattern on the resin layer of 20 nm in thickness located on the imprinting object surface in the same way as that of the first embodiment (see FIGS. 3A to 3D). The groove pattern has a width of 50 nm, a depth of 80 nm, and a pitch of 100 nm corresponding to the fine pattern formed on the surface of the stamper 2.

Note that the charged state of the imprinting surface of the stamper 2 was measured by a static charge gauge, so that the measured voltage value was 0 V.

### (3) Third Embodiment

FIG. 6 is a diagram showing a structure of a stamper 2 according to a third embodiment. The stamper 2 can also be used in the fine structure imprinting machine described in the first embodiment.

The stamper 2 of the third embodiment is manufactured by a different method from that of the first embodiment. That is, although in the first embodiment the pattern 4 is formed after the conductive film 5 is formed on the substrate 3, in a third embodiment, a pattern 4 is formed on the substrate 3 before forming a conductive film 5.

For example, the substrate 3 of the stamper 2 in use is made of a quartz substrate having, for example, a diameter of 100 mm and a thickness of 1.0 mm. Then, grooves having a width of 100 nm, a depth of 100 nm, and a pitch of 200 nm are concentrically formed on the substrate 3 by a known electron beam direct drawing method. Thereafter, ITO material is formed as the conductive film 5 in a thickness of 50 nm by sputtering on the surface with the drawn pattern. Likewise, the ITO material is also formed on the side surface and back side of the stamper 2.

The use of the fine structure imprinting machine with the thus-obtained stamper 2 forms a groove pattern on the resin layer of 20 nm in thickness located on the imprinting object surface in the same way as that of the first embodiment (see FIGS. 3A to 3D). The groove pattern has a width of 100 nm, a depth of 100 nm, and a pitch of 200 nm corresponding to the fine pattern formed on the surface of the stamper 2.

Note that the charged state of the imprinting surface of the stamper 2 was measured by a static charge gauge, so that the measured voltage value was 0 V.

### (4) Fourth Embodiment

FIG. 7 is a diagram showing a structure of a stamper 2 according to a fourth embodiment. The stamper 2 can also be used in the fine structure imprinting machine described in the first embodiment.

The stamper 2 of the fourth embodiment is manufactured by a different method from that of the first embodiment. In the first embodiment the pattern 4 is formed after the conductive film 5 is formed on the substrate 3. In the third embodiment, the pattern 4 is formed on the substrate 3 before forming the conductive film 5. In this embodiment, a pattern 4 is formed by cutting not only the surface of the conductive film 5, but also the substrate 3. Thus, the concentric pattern such as that in the third embodiment is not preferable in this embodiment. This is because lands separated from other parts are formed at the conductive film 5, which cannot release static electricity from the ground. For this reason, at least the conductive film 5 has to be continuously extended on the surface of the stamper 2.

In this embodiment, for example, after sputtering to form the conductive film 5 on the substrate 3, the grooves of 50 nm in width, 80 nm in depth, and 100 nm in pitch are formed parallel by the known electron beam direct drawing method. Further, the conductive film 5 and the substrate 3 are cut down to 50 nm in depth by dry etching using the concavities and convexities formed on the conductive film 5 as a mask. Thus, the conductive film 5 is also etched, which results in the total depth of the groove of 80 nm formed in the pattern 4.

The use of the fine structure imprinting machine with the thus-obtained stamper 2 forms a groove pattern on the resin layer of 20 nm in thickness located on the imprinting object surface in the same way as that of the first embodiment (see FIGS. 3A to 3D). The groove pattern has a width of 50 nm, a depth of 80 nm, and a pitch of 100 nm corresponding to the fine pattern formed on the surface of the stamper 2.

Note that the charged state of the imprinting surface of the stamper 2 was measured by a static charge gauge, so that the measured voltage value was 0 V.

### (5) Fifth Embodiment

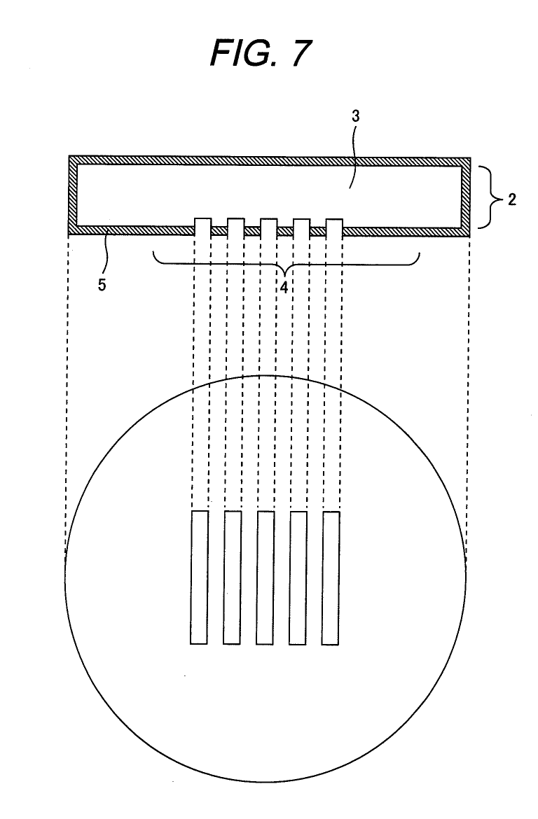

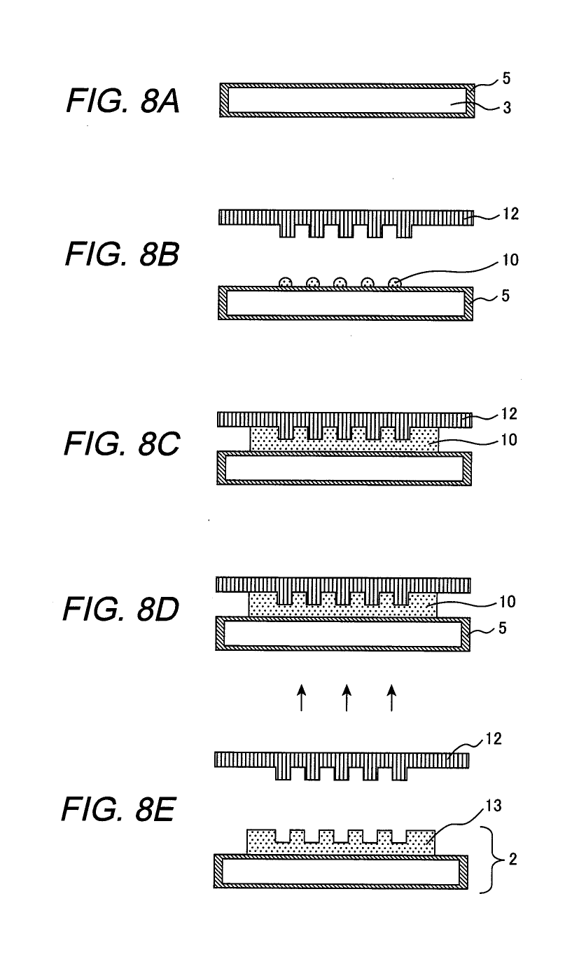

FIGS. 8A to 8E are diagrams showing a structure and a manufacturing method of a stamper 2 according to a fifth embodiment. The stamper 2 can also be used in the fine structure imprinting machine described in the first embodiment.

The stamper 2 of the fifth embodiment is manufactured by a different method from that of the first embodiment. The method for manufacturing the stamper 2 according to the fifth embodiment will be described below with reference to FIGS. 8A to 8E.

First, ITO is deposited on the periphery of the substrate (made of a transparent material, such as quartz or resin) 3 by sputtering to form the conductive film 5 (see FIG. 8A). Then, the light curing resin 10 is applied to the conductive film 5 (see FIG. 8B). Subsequently, the stamper 12 is pressed against the conductive film 5 to expand the light curing resin 10 applied on the conductive film 5. At this time, a stamper (for example, made of opaque Si material) 12 in use has grooves concentrically patterned, for example, by the known electron beam direct drawing method (see FIG. 8C). The groove has a width of 50 nm, a depth of 80 nm, and a pitch of 100 nm.

Then, ultraviolet rays are applied from the back side of the conductive film 5 to cure the light curing resin 10 (see FIG. 8D). After curing the light curing resin 10, the stamper 12 is removed thereby to obtain a stamper 2 with a pattern layer 13 onto which a fine pattern of the stamper 12 is imprinted (FIG. 8E). A mold release process is preferably performed by forming the known fluorinated mold release agent over the surface of the pattern layer 13 of the stamper 2.

The use of the thus-obtained stamper 2 forms a groove pattern on the resin layer of 20 nm in thickness located on the imprinting object surface in the same way as that of the first embodiment (see FIGS. 3A to 3D). The groove pattern has a width of 50 nm, a depth of 80 nm, and a pitch of 100 nm corresponding to the fine pattern formed on the surface of the stamper 2.

Note that the charged state of the imprinting surface of the stamper 2 was measured by a static charge gauge, so that the measured voltage value was 0 V.

### (6) Sixth Embodiment

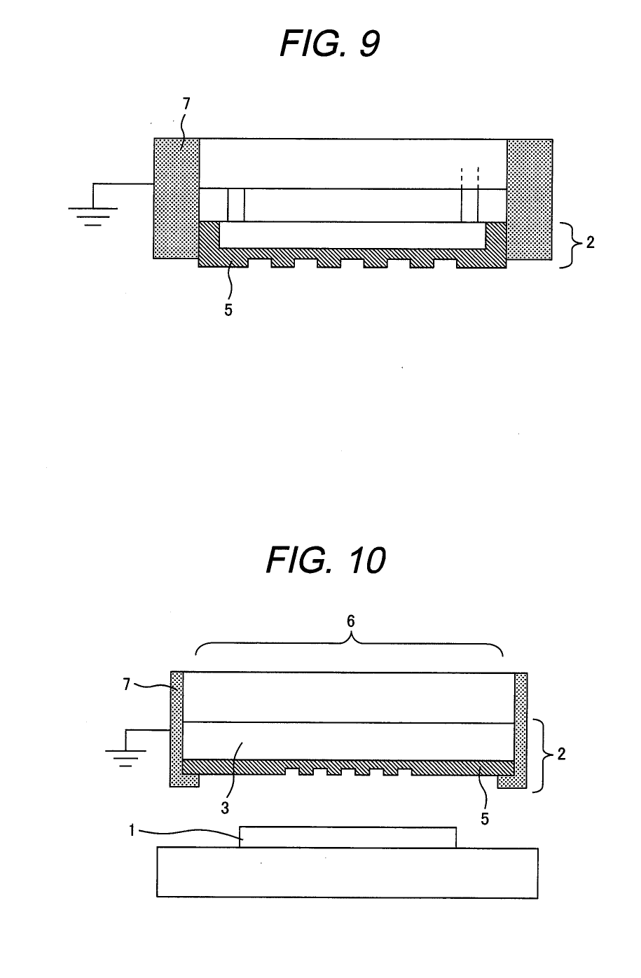

FIG. 9 is a schematic diagram showing a structure of a fine structure imprinting machine according to a sixth embodiment. This embodiment differs from the first embodiment in the structures of the stamper 2 and the stamper holding member 7, and in the method for holding the stamper 2.

The stamper 2 of the first embodiment also has the conductive film 5 formed on the back side of the imprinting surface (the surface with the pattern 4 formed thereon). However, the stamper 2 of this embodiment has the conductive films 5 formed only on the same imprinting surface and the side surface thereof. In the first embodiment, the stamper holding member 7 is configured to be in contact with the conductive film 5 on the back side of the formation surface of the pattern 4 of the stamper 2. In contrast, the stamper holding member 7 of this embodiment is configured to be in contact with the conductive film 5 on the side surface of the stamper 2. In this way, the transmittance of UV rays is improved. The imprinting surface of the stamper 2 may have a pattern such as that shown in FIG. 7.

The use of the thus-obtained fine structure imprinting machine forms a groove pattern on the resin layer of 20 nm in thickness located on the imprinting object surface in the same way as that of the first embodiment (see FIGS. 3A to 3D). The groove pattern has a width of 50 nm, a depth of 80 nm, and a pitch of 100 nm corresponding to the fine pattern formed on the surface of the stamper 2.

Note that the charged state of the imprinting surface of the stamper 2 was measured by a static charge gauge, so that the measured voltage value was 0 V.

### (7) Seventh Embodiment

FIG. 10 is a schematic diagram showing a structure of a fine structure imprinting machine according to a seventh embodiment. This embodiment differs from the first embodiment in the structures of the stamper 2 and the stamper holding member 7, in the method for holding the stamper 2, and in outer diameter of the imprinting object 1.

Although in the first embodiment the stamper 2 has the conductive films 5 formed on the imprinting surface, the side surface thereof, and the back side of the imprinting surface, the stamper 2 in this embodiment has the conductive film 5 formed only on the imprinting surface.

In the first embodiment, the stamper 2 is held by a suction effect of the vacuum suction port 8 provided in the plate 6. However, in this embodiment, the stamper 2 is fixed to and in contact with the conductive film 5 formed on the imprinting surface by use of the stamper holding member 7. Thus, the vacuum suction port 8 may not be provided in the plate 6. The imprinting surface of the stamper 2 may have the pattern such as that shown in FIG. 7.

The imprinting object 1 in use is made of a glass substrate having, for example, a diameter of 100 mm and a thickness of 0.7 mm, but may have any applicable size.

The use of the thus-obtained fine structure imprinting machine forms a groove pattern on the resin layer of 20 nm in thickness located on the imprinting object surface in the same way as that of the first embodiment (see FIGS. 3A to 3D). The groove pattern has a width of 50 nm, a depth of 80 nm, and a pitch of 100 nm corresponding to the fine pattern formed on the surface of the stamper 2.

Note that the charged state of the imprinting surface of the stamper 2 was measured by a static charge gauge, so that the measured voltage value was 0 V.

### (8) Application Example 1

In this application example, a sample having a fine pattern for a large-capacity magnetic recording medium (discrete track medium) imprinted thereon is manufactured by use of the fine structure imprinting machine of the first embodiment (see FIG. 1). The imprinting object 1 in use is made of a glass substrate for the magnetic recording medium, having a diameter of 65 mm, a thickness of 0.631 mm, and a diameter of a center hole of 20 mm.

Resin is put by drops onto the surface of the glass disk substrate using an ink-jet mechanism. Photosensitive material is added to the resin, which is adjusted to have a viscosity of 4 mPA·s. The resin is applied by a coating head including 512 nozzles (256×2 columns) for discharging resin by a piezoelectric system. A distance between the nozzles of the coating head is 70 μm in the direction of column, and 140 μm in the direction of the distance between the columns. The nozzles are controlled so as to discharge the resin of about 5 PL from each nozzle. A drop pitch of the resin may be 150 μm in the radial direction, and 270 μm in the circumferential direction.

The imprinting object with the groove pattern corresponding to the fine pattern formed on the surface of the stamper 2 is manufactured on the surface of the glass substrate in the same way as that of the first embodiment. The groove pattern has a width of 50 nm, a depth of 80 nm, and a pitch of 100 nm.

Now, various embodiments of a method for manufacturing a discrete medium will be described below.

### (Discrete Medium Manufacturing Method (1))

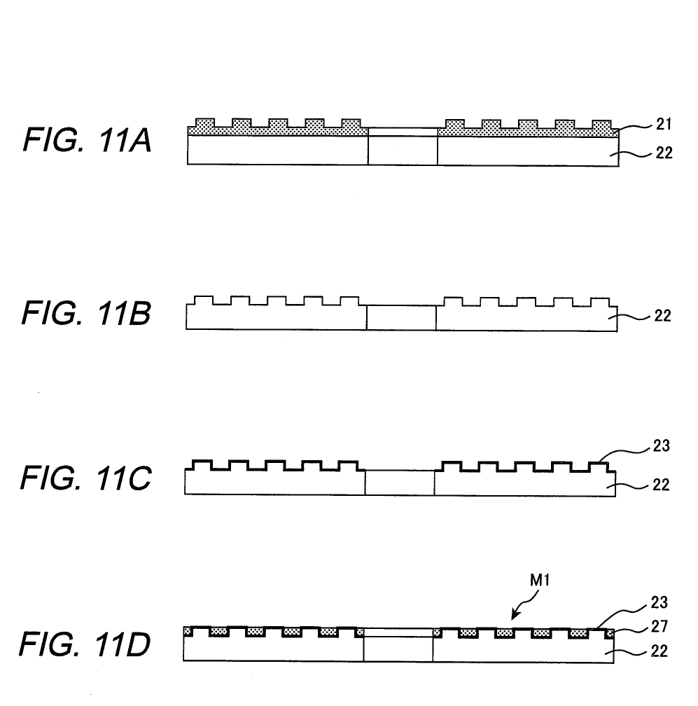

A manufacturing method (1) of a discrete track medium using the above fine structure imprinting machine of the invention will be described below with reference to the accompanying drawings. In the drawings for reference, FIGS. 11A to 11D are explanatory diagrams showing manufacturing steps of the discrete track medium.

First, as shown in FIG. 11A, a glass substrate 22 having thereon a pattern formation layer 21 made of the light curing resin 10 onto which the surface shape of the stamper 2 is imprinted is prepared.

Then, the surface of the glass substrate 22 is processed by the known dry etching using the pattern formation layer 21 as a mask. As a result, as shown in FIG. 11B, concavities and convexities corresponding to the pattern on the pattern formation layer 21 are formed on the surface of the substrate 22. Fluorinated gas is used in the dry etching. The dry etching may involve removing thin parts of the pattern formation layer 21 by oxygen plasma etching, and then etching parts of the glass substrate 22 exposed to the fluorinated gas.

Then, as shown in FIG. 11C, a magnetic recording medium formation layer 23 constructed of a precoat layer, a magnetic domain control layer, a soft magnetic underlayer, an intermediate layer, a vertical recording layer, and a protective layer is formed on the glass substrate 22 with the concavities and convexities formed thereon by DC magnetron sputtering (see, for example, JP-A-No. 038596/2005). The magnetic domain control layer is formed of a nonmagnetic layer and an antiferromagnetic layer.

Then, as shown in FIG. 1D, a nonmagnetic member 27 is attached to the magnetic recording medium formation layer 23 to flatten the surface of the glass substrate 22. As a result, a discrete track medium Ml having a surface recording density of about 200 GbPsi is obtained.

### (Discrete Medium Manufacturing Method (2))

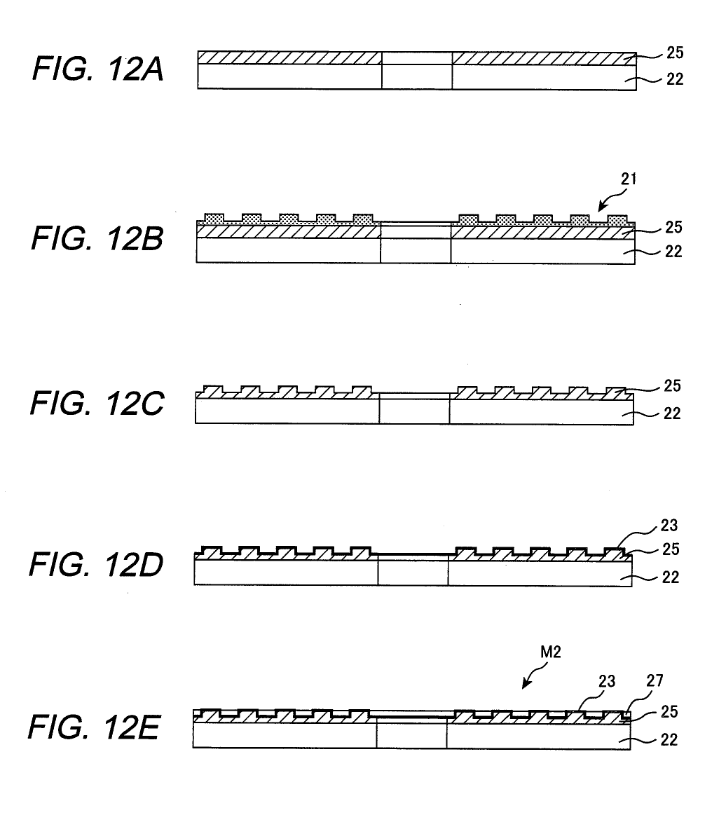

A manufacturing method of a discrete track medium using the above fine structure imprinting method of the invention will be described below with reference to the accompanying drawings. In the drawings for reference, FIGS. 12A to 12E are explanatory diagrams showing manufacturing steps of the discrete track medium.

The following substrate is prepared instead of the glass substrate 22 with the pattern formation layer 21. The substrate has a soft magnetic underlayer 25 formed on the glass substrate 22 as shown in FIG. 12B. Then, the pattern formation layer 21 made of the light curing resin 6 and onto which the surface shape of the stamper 2 is imprinted is formed over the substrate in the same way as that of the first embodiment (see FIGS. 3A to 3D).

Then, the surface of the soft magnetic underlayer 25 is processed by the known dry etching using the pattern formation layer 21 as a mask. As a result, as shown in FIG. 12C, the concavities and convexities corresponding to the pattern on the pattern formation layer 21 are formed on the surface of the soft magnetic underlayer 25. The fluorinated gas is used in the dry etching.

Then, as shown in FIG. 12D, a magnetic recording medium formation layer 23 constructed of a precoat layer, a magnetic domain control layer, a soft magnetic underlayer, an intermediate layer, a vertical recording layer, and a protective layer is formed on the soft magnetic underlayer 25 with the concavities and convexities formed thereon by the DC magnetron sputtering (see, for example, JP-A-No. 038596/2005). The magnetic domain control layer is formed of a nonmagnetic layer and an antiferromagnetic layer.

Referring to FIG. 12E, the nonmagnetic member 27 is attached to the magnetic recording medium formation layer 23 to flatten the surface of the soft magnetic underlayer 25. As a result, a discrete track medium M2 having a surface recording density of about 200 GbPsi is obtained.

### (Discrete Medium Manufacturing Method (3))

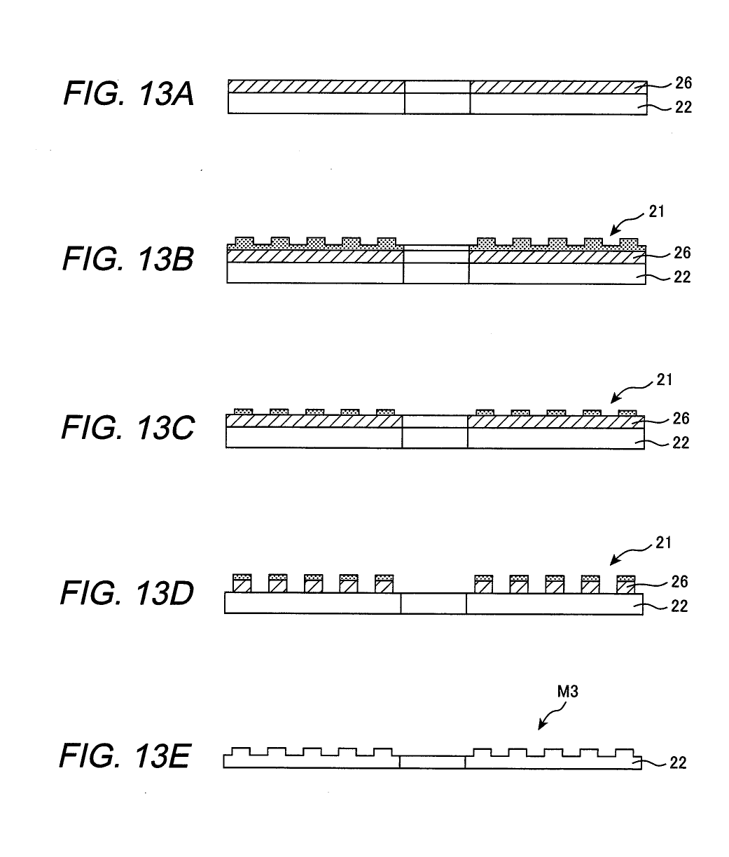

A manufacturing method (3) of a disk substrate for a discrete track medium using the above fine structure imprinting machine of the invention will be described below with reference to the accompanying drawings. In the drawings for reference, FIGS. 13A to 13E are explanatory diagrams showing manufacturing steps of the disk substrate for the discrete track medium.

Referring to FIG. 13A, a flattening layer 26 is previously formed on the surface of the glass substrate 22 by applying novolac resin material thereon. The flattening layer 26 can be formed by a spin coat method, or by means for pressing resin against the substrate using a flat plate. Then, as shown in FIG. 13B, the pattern formation layer 21 is formed on the flattening layer 26. The pattern formation layer 21 is formed by applying resin material containing silicon on the flattening layer 26, and forming the pattern using the fine structure imprinting method of the invention.

As shown in FIG. 13C, thin parts of the pattern formation layer 21 are removed by the dry etching using the fluorinated gas. Then, as shown in FIG. 13D, the flattening layer 26 is removed by oxygen plasma etching using the remaining parts of the pattern forming layer 21 as a mask. The surface of the glass substrate 22 is etched by the fluorinated gas to remove the remaining pattern formation layer 21, so that a disk substrate M3 to be used in the discrete track medium having a surface recording density of about 200 GbPsi is obtained as shown in FIG. 13E.

### (Discrete Medium Manufacturing Method (4))

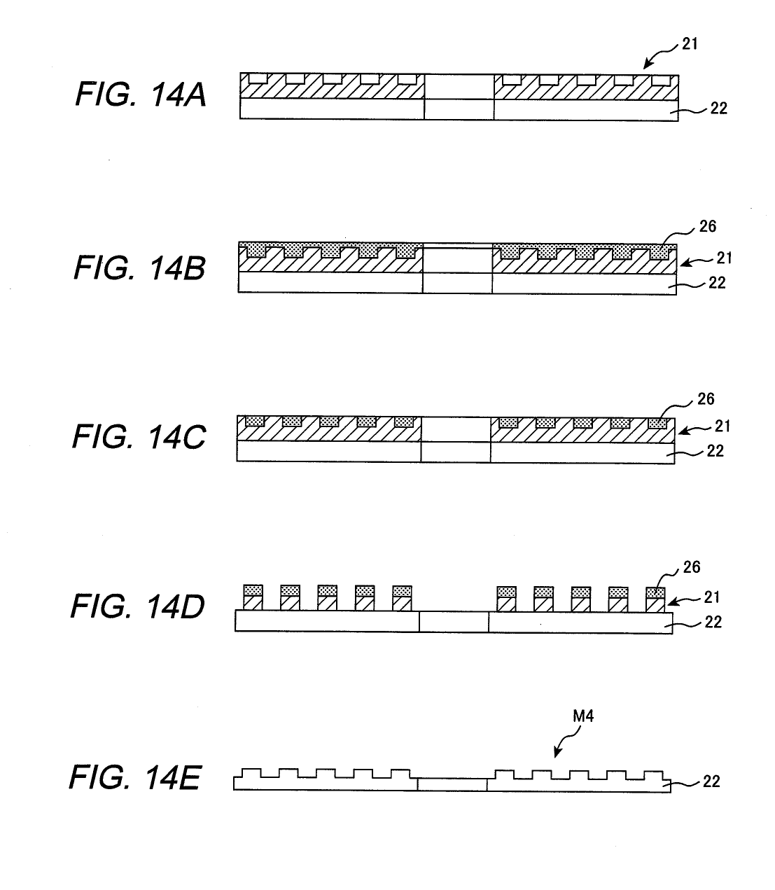

A manufacturing method (4) of a disk substrate for a discrete track medium using the above fine structure imprinting machine of the invention will be described below with reference to the accompanying drawings. In the drawings for reference, FIGS. 14A to 14E are explanatory diagrams showing manufacturing steps of the disk substrate for the discrete track medium.

Referring to FIG. 14A, acrylate resin to which photosensitive material is added is applied to the surface of the glass substrate 22, and then the pattern formation layer 21 is formed over the glass substrate 22 by the fine structure imprinting method of the invention. In this application example, a pattern having concavities and convexities which are reversed with respect to a pattern to be formed is formed over the glass substrate 22. Then, as shown in FIG. 14B, resin material containing silicon and photosensitive material is applied to the surface of the pattern formation layer 21 to form the flattening layer 26. The flattening layer 26 can be formed by a spin coat method, or by means for pressing resin against the substrate using a flat plate. Referring to FIG. 14C, when the surface of the flattening layer 26 is etched by fluorinated gas, the uppermost surface of the pattern formation layer 21 is exposed. Then, as shown in FIG. 14D, the pattern formation layer 21 is removed by oxygen plasma etching using the remaining parts of the flattening layer 26 as a mask, causing the surface of the glass substrate 22 to be partly exposed. As shown in FIG. 14E, the surface of the exposed glass substrate 22 is etched by fluorinated gas, so that a disk substrate M4 to be used in the discrete track medium having a surface recording density of about 200 GbPsi is obtained.

### (9) Application Example 2

Subsequently, an optical information processor manufactured using the above-mentioned fine structure imprinting method of the invention will be described below.

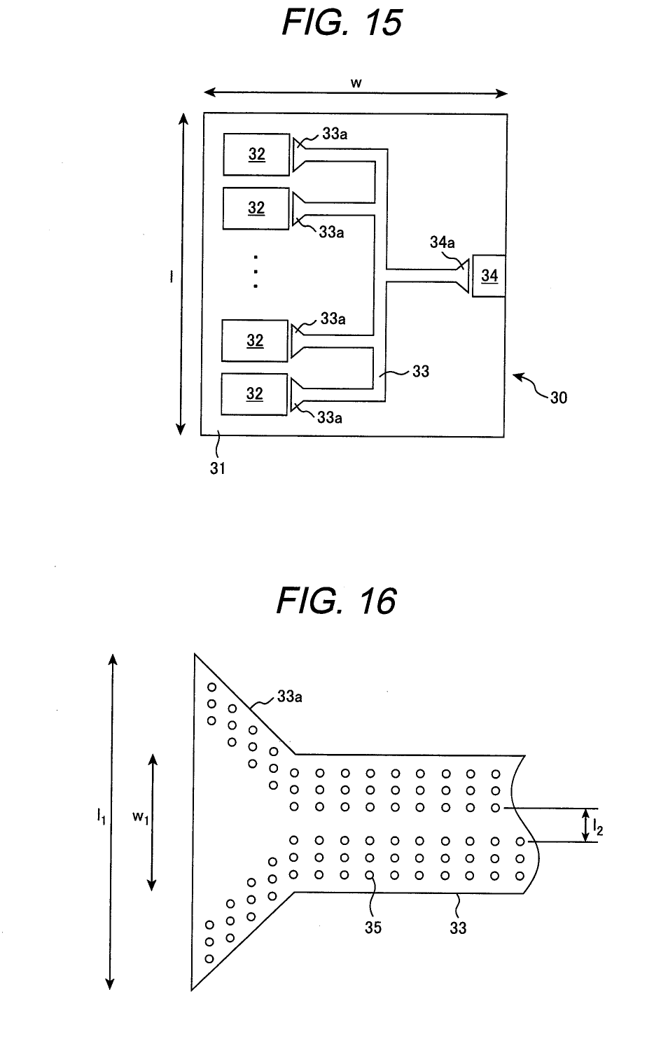

In this application example, an optical device in which the traveling direction of incident light is changeable is applied to an optical information processor of an optical multiplexing communication system. FIG. 15 is a schematic diagram of an optical circuit serving as a basic component of the optical device. FIG. 16 is a schematic diagram showing the structure of a waveguide of the optical circuit.

As shown in FIG. 15, an optical circuit 30 is formed on an aluminum nitride substrate 31 measuring 30 mm in length by 5 mm in width by 1 mm in thickness. The optical circuit 30 includes a plurality of transmission units 32 which include an indium phosphorus semiconductor laser and a driver circuit, optical waveguides 33 and 33a, and optical connectors 34 and 34a. Oscillation wavelengths from the respective semiconductor lasers are set to differ from each other by 2 to 50 nm.

In the optical circuit 30, optical signals input from the transmission units 32 are transmitted from the optical connector 34a to the optical connector 34 via the waveguide 33a and the waveguide 33. In this case, the optical signals are merged from the respective waveguides 33a.

As shown in FIG. 16, a plurality of columnar fine protrusions 35 stand within the waveguide 33. The width (W₁) of an input portion of the waveguide 33a is set to 20 μm, and has a horn-like shape as viewed in the plane cross section so as to allow an alignment error between the transmission unit 32 and the waveguide 33. Only one line of columnar fine protrusions 35 are removed at the center of a straight portion forming the waveguide 33. That is, an area without a photonic band gap is formed, which guides signal light to an area (W₁) of 1 μm in width. A distance (pitch) between the columnar fine protrusions 35 is set to 0.5 μm. In FIG. 16, for simplification, the number of the columnar fine protrusions 35 is shown to be smaller than that of protrusions actually formed.

The invention is applied to the waveguides 33 and 33a, and the optical connector 34a. That is, relative positional alignment of the substrate 31 and the stamper 2 (see FIG. 1 and the like) is performed using the fine structure imprinting method of the invention. The fine structure imprinting method is applied in forming a predetermined columnar fine protrusion 35 in a predetermined transmission unit 32 when the columnar fine protrusions 35 are formed within the transmission unit 32. The optical connector 34a has a structure that is laterally reversed with respect to the waveguide 33a shown in FIG. 15. The columnar fine protrusions 35 of the optical connector 34a are arranged to be laterally reversed with respect to the columnar fine protrusions 35 shown in FIG. 16.

The equivalent diameter of the columnar fine protrusion 35 (diameter or length of one side) can be set any value of 10 nm to 10 μm from the viewpoint of the relationship with wavelengths of a light source used in a semiconductor laser or the like.

The height of the columnar fine protrusion 35 is preferably in a range of 50 nm to 10 μm. The distance (pitch) of the columnar fine protrusion 35 is set to about half a wavelength of the signal to be used.

Such an optical circuit 30 can output signal lights with different wavelengths which are superimposed on each other, and also can change the traveling direction of each light. Thus, the width (W) of the optical circuit 30 can be decreased to a very small value of, about 5 mm. This can downsize the optical device. The fine structure imprinting method can form the columnar fine protrusions 35 by imprinting using the stamper 2 (see FIG. 1 or the like), thereby reducing the manufacturing cost of the optical circuit 30. In this example, the invention is applied to the optical device using the superimposed input lights. However, the invention is not limited thereto, and can be suitable for use in all optical devices for controlling an optical route.

### (10) Application Example 3

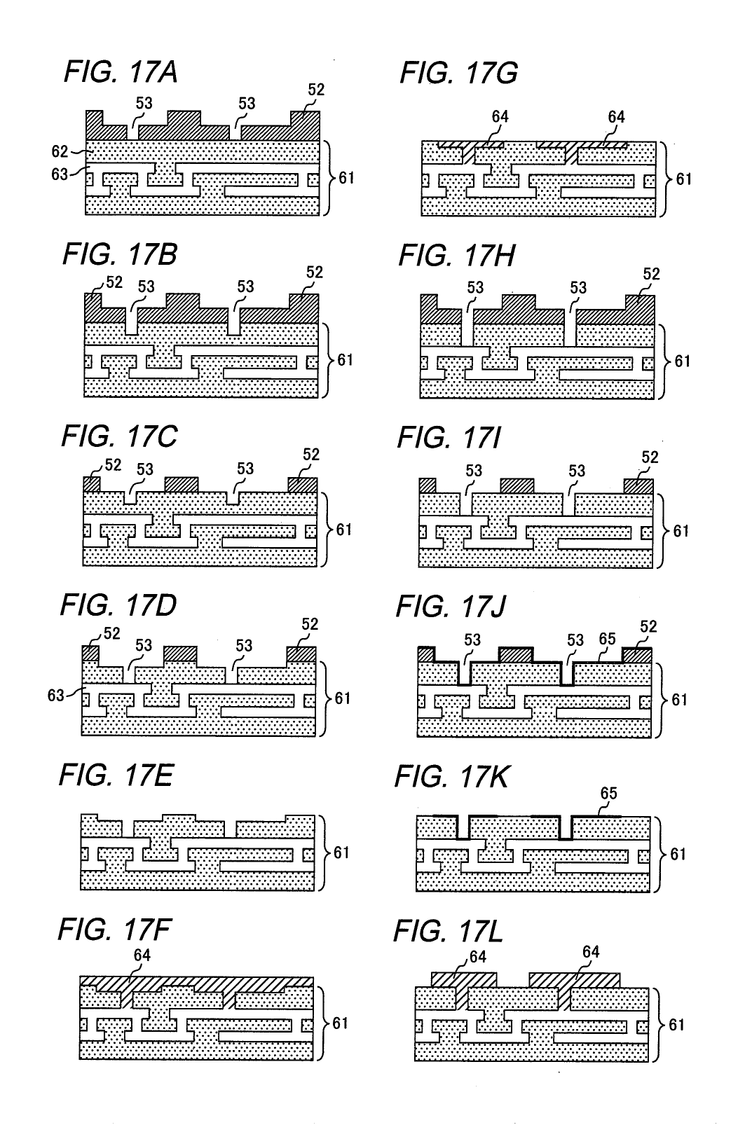

Now, a method for manufacturing a multilayer wiring board using the above-mentioned fine structure imprinting method of the invention will be described below. FIGS. 17A to 17L are explanatory diagrams of manufacturing steps of the multilayer wiring board.

As shown in FIG. 17A, a pattern is imprinted by a stamper (not shown) after a resist 52 is formed on the surface of a multilayer wiring board 61 including a silicon oxide film 62 and a copper wiring 63. Before imprinting the pattern, the stamper 2 is aligned with the substrate in terms of the relative position, and then the desired wiring pattern is imprinted onto a predetermined position of the substrate.

After exposed areas 53 of the multilayer wiring substrate 61 is dry etched using CF₄/H₂ gas, the exposed areas 53 on the surface of the substrate 61 are formed into grooves as shown in FIG. 17B. Then, the resist 52 is etched by reactive ion etching (RIE). After lower stepped parts of the resist are completely removed by the resist etching, the exposed areas 53 of the multilayer wiring substrate 61 expand around the resist 52 as shown in FIG. 17C. Further, the exposed areas 53 in this state are subjected to dry etching, so that the bottoms of the formed grooves reach the copper wiring 63 at some depth as shown in FIG. 17D.

Then, the resist 52 is removed, whereby the multilayer wiring board 61 having grooves formed thereon is obtained as shown in FIG. 17E. After forming a metal film (not shown) on the surface of the multilayer wiring board 61, as shown in FIG. 17F, a metal plating film 64 is formed by electrolytic plating. Thereafter, the metal plating film 64 is polished until the silicon oxide film 62 of the multilayer wiring substrate 61 is exposed. As a result, referring to FIG. 17G, the multi wiring substrate 61 having metal wirings made of the metal plating film 64 on the surface thereof is thus obtained.

Other steps of manufacturing the multilayer wiring substrate 61 will be described below.

When the exposed areas 53 in the state shown in FIG. 17A are subjected to the dry etching, the etching is continued until the grooves reach the copper wiring 63 inside the multilayer wiring board 61 as shown in FIG. 17H. Then, the resist 52 is etched by the RIE, whereby the lower stepped parts of the resist 52 are removed as shown in FIG. 17I. As shown in FIG. 17J, a metal film 65 is formed by sputtering on the surface of the multilayer wiring substrate 61. Then, the resist 52 is removed by a liftoff process, so that the metal film 65 partly remains on the surface of the multilayer wiring substrate 61 as shown in FIG. 17K. Thereafter, the remaining metal film 65 is subjected to electroless plating, whereby the multi wiring substrate 61 having metal wirings made of a metal film 64 on the surface thereof is obtained as shown in FIG. 17L. Accordingly, the invention can be applied to the manufacturing of the multilayer wiring substrate 61, thereby forming a metal wiring with high dimensional accuracy.

What is claimed is:

1. A fine structure imprinting machine for bringing a stamper with a fine concavo-convex pattern formed thereon into contact with an imprinting object thereby to imprint the fine concavo-convex pattern of the stamper onto a surface of the imprinting object, said imprinting machine comprising:
a stamper holding member for holding the stamper,
wherein the stamper has a conductive film formed on at least an imprinting surface where the fine concavo-convex pattern is formed,
wherein the stamper holding member has a conductor having electrical conductivity, and
wherein the conductive film is connected to the stamper holding member via the conductor, and the conductor of the stamper holding member is connected to a ground.

2. The fine structure imprinting machine according to claim 1, wherein the conductive film of the stamper is formed on at least the uppermost surface of a convexity of the concavo-convex pattern.

3. The fine structure imprinting machine according to claim 1, wherein the stamper holding member holds the stamper by vacuum suction.

4. The fine structure imprinting machine according to claim 2,wherein the stamper has the conductive film continuously formed over the imprinting surface, a back side of the imprinting surface, and a side surface of the stamper, and
wherein the conductor is in contact with the back side of the imprinting surface of the stamper.

5. The fine structure imprinting machine according to claim 2, wherein the stamper has the conductive films formed on the imprinting surface and the back side of the imprinting surface, and is provided with a conductive path for establishing conduction between the imprinting surface and the back side of the imprinting surface, and
wherein the conductor is in contact with the back side of the imprinting surface of the stamper.

6. The fine structure imprinting machine according to claim 2, wherein the stamper has the conductive film continuously formed over the imprinting surface, and the side surface thereof, and
wherein the conductor is in contact with the side surface of the stamper.

7. The fine structure imprinting machine according to claim 1, wherein the stamper holding member places and holds an outer periphery of the imprinting surface of the stamper, and
wherein the conductor is connected to the imprinting surface of the stamper.
